(19) United States
(12) Patent Application Publication
(10) Pub. No.: US 2009/0201897 A1
(43) Pub. Date: Aug. 13, 2009

(54) CLASSIFICATION PROCESS INVOLVING MOBILE STATIONS

(75) Inventors: Basavaraj Patil, Coppell, TX (US); Domagoj Premec, Zagreb (HR)

Correspondence Address: BRAKE HUGHES BELLERMANN LLP, c/o CPA Global, P.O. BOX 52050, MINNEAPOLIS, MN, 55402, US

(73) Assignee: Nokia Siemens Networks Oy, Espoo (FI)

(21) Appl. No.: 12/029,334

(22) Filed: Feb. 11, 2008

(51) Int. Cl. H04Q 7/24

(52) U.S. Cl. 370/338

(57) ABSTRACT

Various example embodiments are disclosed herein. In an example embodiment, a method may comprise receiving data from a home agent, wherein the data is directed to a mobile station that is coupled with a foreign network and the data includes an outer header having a foreign network address associated with the mobile station and an encapsulated header having a home network address associated with the mobile station; reading the encapsulated header to determine the home network address; and performing data classification using at least the home network address of the encapsulated header.

### TECHNICAL FIELD

This description relates to wireless networks.

### BACKGROUND

Typically, network providers (e.g., Internet service providers (ISPs)) operate fixed networks. The provider networks often provide a plurality of services that a subscriber may access as desired. Many of these services may be limited by a usage agreement or by a subscription plan. For example, often users may subscribe to certain bandwidth limitations or to a level of services. As users desire more services, they may increase their subscription levels. For example users may increase their bandwidth limitation or add additional features or services.

Increasingly users or subscribers want to roam or move freely from place to place. As such, the subscriber may move to a location that is not directly serviced by the provider network. For example, a subscriber may directly connect with a provider network from the subscriber's home, but when the subscriber is on a trip or at a restaurant they may not be able to interact with the provider network. In some instances these remote locations may have access to another network. A user may wish to traverse the remote or foreign network to access the home or provider's network. In this context, the network traversed to access the home or provider network may be referred to as a “foreign network”. To access the network the subscriber may use any of a number of devices, such as, for example, a cell phone, a personal digital assistant (PDA), a laptop computer, a desktop computer, etc.; although, it is understood that the above are merely a few illustrative examples to which the disclosed subject matter is not limited.

### SUMMARY

According to an example embodiment, a method comprising: receiving data from a home agent, wherein the data is directed to a mobile station that is coupled with a foreign network and the data includes an outer header having a foreign network address associated with the mobile station and an encapsulated header having a home network address associated with the mobile station; reading the encapsulated header to determine the home network address; and performing data classification using at least the home network address of the encapsulated header.

According to an example embodiment, an apparatus comprising: a data receiver configured to receive data, wherein the data is directed to a mobile station that is coupled with a foreign network and the data includes an outer header having a foreign network address associated with the mobile station and an encapsulated header having a home network address associated with the mobile station; a data classifier configured to: read the encapsulated header to determine the home network address, and assign the data to a data service flow using at least the home network address of the encapsulated header; and a data transmitter configured to transmit the data to the foreign network address.

According to an example embodiment, a system comprising: a base station configured to communicatively couple a mobile station with a foreign network, wherein the mobile station is configured to communicate with a home network via a foreign network and the mobile station is associated with a home network address and a care-of foreign network address; and an access network gateway configured to: communicatively couple the foreign network with the home network, transfer data between the mobile station and the home network, wherein the data includes an outer header having the care-of foreign network address associated with the mobile station and an encapsulated header having a home network address associated with the mobile station, and assign the data to a data service flow based, at least in part, upon the home network address associated with the mobile station.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a wireless network in accordance with an example embodiment of the disclosed subject matter.

FIG. 2 is a block diagram illustrating a system in accordance with an example embodiment of the disclosed subject matter.

FIG. 3 is a block diagram illustrating an apparatus in accordance with an example embodiment of the disclosed subject matter.

FIG. 4 is a flow chart illustrating a technique in accordance with an example embodiment of the disclosed subject matter.

FIG. 5 is a block diagram of a wireless node in accordance with an example embodiment of the disclosed subject matter.

### DETAILED DESCRIPTION

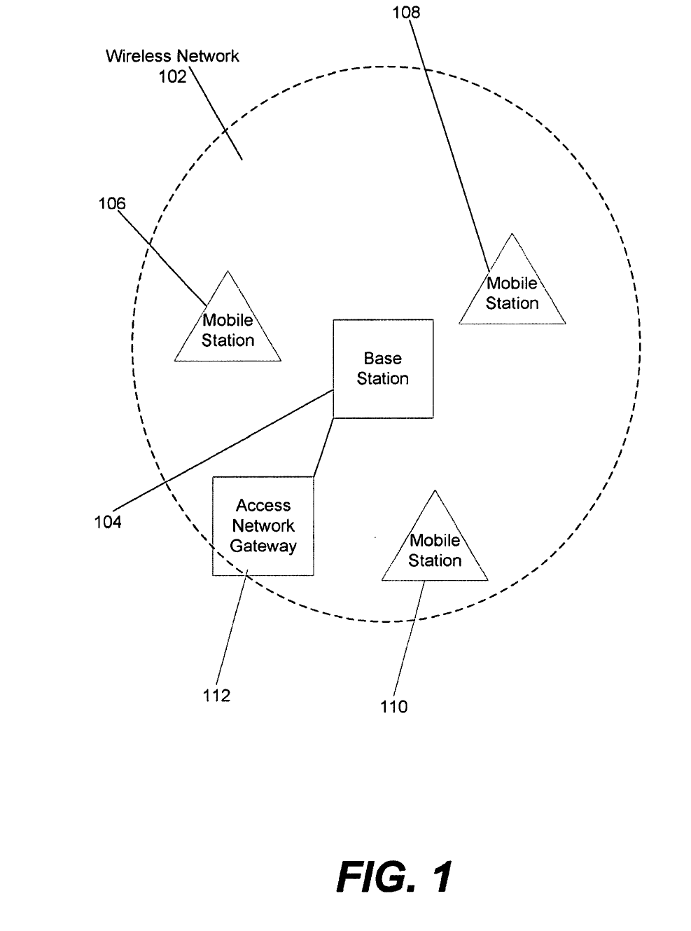

Referring to the Figures in which like numerals indicate like elements, FIG. 1 is a block diagram of a wireless network 102 including a base station (BS) 104 and mobile stations (MS) 106, 108, 110, according to an example embodiment. Each of the MSs 106, 108, 110 may be associated with BS 104, and may transmit data in an uplink direction to BS 104, and may receive data in a downlink direction from BS 104, for example. Although only one BS 104 and three mobile stations (MS 106, 108 and 110) are shown, any number of base stations and mobile stations may be provided in network 102. Also, although not shown, mobile stations 106, 108 and 110 may be coupled to base station 104 via relay stations or relay nodes, for example. An access network controller or gateway 112 may be coupled to the base stations (e.g., BS 104) via wired or wireless links. In an example embodiment, access network gateway 112, if present, may provide control for one or more network tasks or functions, either for or in cooperation with one or more base stations in network 102. Although not shown, access network gateway 112 and base station 104 may each be connected to a wired network, such as a Local Area Network, a Wide Area Network (WAN), the Internet, etc..

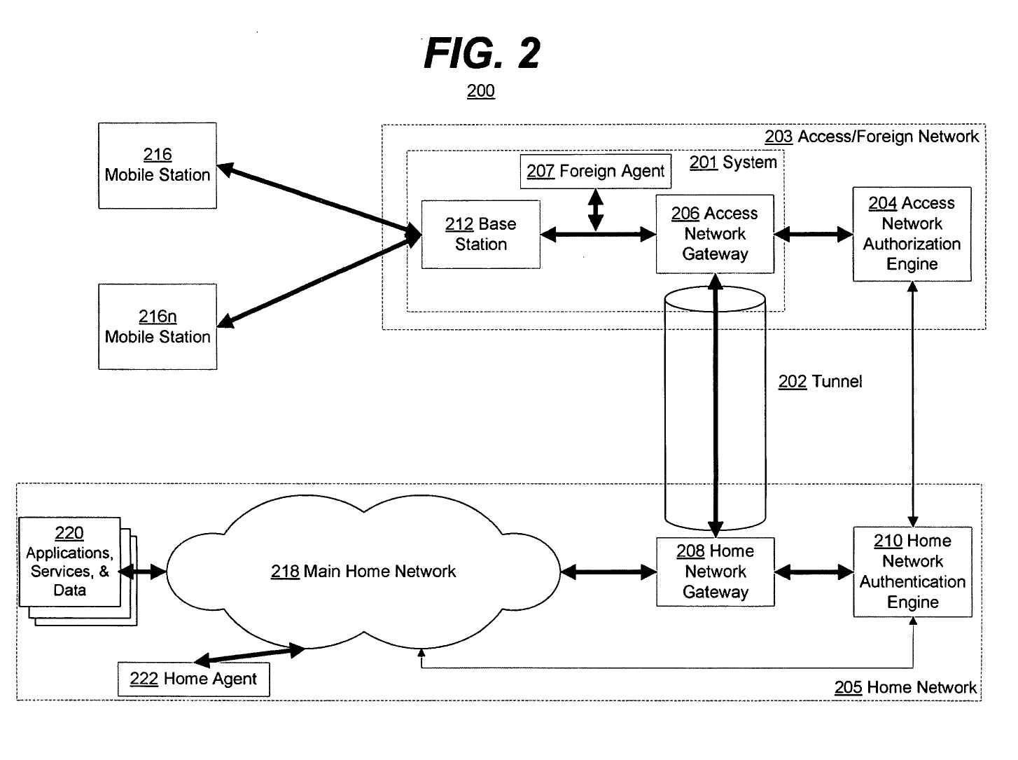

FIG. 2 is a block diagram illustrating a system 201 in accordance with the disclosed subject matter. In one embodiment, the system 201 may include a base station 212 and an access network gateway 206. In one embodiment, the system 201 may be part of an access or foreign network 203. Such a foreign network 203 may include the system 201 and an access network authorization engine 204. In one embodiment, a system 200 may include a plurality of mobile stations 216 and 216n, the foreign network 203, a home network 205, and a tunnel 202 providing access between the foreign network 203 and the home network 205. In one embodiment, the home network 205 may include a home network gateway 208, a home network authorization engine 210, a home agent 222, and a main home network 218 that may include a plurality of applications, services and data 220.

The following is a brief orienting discussion of various embodiments of usage of a mobile station within a foreign network. As described above, a mobile station 216 may be physically remote from a home network 205 and communicatively coupled with a foreign network 203, but may wish to access the home network 205 as if the mobile station 216 was part of the home network 205. In one embodiment, the mobile station 216 may be associated with multiple network addresses. In such an embodiment, the mobile station 216 may be associated with a home network address. Such an address may be an address within the home network 205 that allows the mobile station 216 to appear as if it is part of the home network 205. In such an embodiment, the mobile station 216 may also be associated with a foreign network address. Such an address may be an address on the foreign network 203 that allows the mobile station to appear as if it is part of foreign network 203.

In one embodiment, when a node (e.g., a service 220) wishes to communicate with the mobile station 216, it may send data to the mobile station's home network address. The data may be intercepted or forwarded by a home agent 222 that has knowledge of the foreign network address of the mobile station 216. In one embodiment, this home agent 222 may then wrap or encapsulate the original data in an outer header that contains the foreign network address associated with the mobile station 216 and transmit the data to the foreign network address. In one embodiment, the home agent 222 may also be a home network gateway 208 that transmits the data via a tunnel 202 to an access network gateway 206 and ultimately to the mobile station 216.

In various embodiments, the foreign network address may be referred to as a “care-of-address”. Such a care-of-address may be a valid network address within the foreign network 203. The foreign network address may allow the foreign network 203 to route data to the mobile station 216. Two general embodiments of care-of-addressing may be used and known as “co-located care-of address” mode and “foreign agent care-of address” mode; although, it is understood that the above are merely a few illustrative examples to which the disclosed subject matter is not limited.

In one embodiment thought of as “co-located care-of address” mode, the mobile station 216 may be directly assigned both the foreign network address and the home network address. Such an embodiment may occur when network addresses are relatively plentiful, such as, for example, when using Internet Protocol version 6 (IPv6). In such an embodiment, data may be directly routed to the mobile station 216 using the assigned foreign network address. In such an embodiment, the tunnel 202 may extend from the home network gateway 208 to the mobile station 216, via the access network gateway 206.

In yet another embodiment thought of as “foreign agent care-of address” mode, the mobile station 216 may be directly assigned the home network address, but merely associated with the foreign network address. The foreign network address may instead be directly assigned to the foreign agent 207 or other third party entity. In various embodiments, the foreign network address assigned to the foreign agent 207 may be associated with multiple mobile stations (e.g., both mobile stations 216 and 216n). Such an embodiment may occur when network addresses are relatively scarce, such as, for example, when using Internet Protocol version 4 (IPv4). In such an embodiment, the tunnel 202 may extend from the home network gateway 208 to the foreign agent 207. In such an embodiment, the data may be routed to the foreign agent 207 using the foreign network address. The foreign agent 207 may then route the data to the proper mobile station similar to, in one embodiment, Network Address Translation (NAT). As such, the foreign network addressing may be analogous to the “care of” or “c/o” addressing format commonly used with physical letters, in which a letter is meant for a particular recipient but addressed to a third party. In various embodiments, the Access Network Gateway 206 may act as the foreign agent 207.

In one embodiment, the mobile station 216 may utilize a protocol that facilities wireless networking on both a foreign network 203 and a home network 205. In such an embodiment, the mobile station 216 may use a protocol sufficiently compliant with Mobile Internet Protocol (IP) for IP version six (6) (a.k.a. “MobileIP”), its derivatives, or predecessors. Mobility Support in IPv6, The Internet Society: Network Working Group, RFC 3775, June 2004.

In one embodiment, the foreign network 203 may include a WiMAX (Worldwide Interoperability for Microwave Access) based network that is substantially incompliance with the IEEE 802.16 standards, their derivatives, or predecessors. Institute of Electrical and Electronics Engineers, IEEE Standard for Local and Metropolitan Area Networks, Part 16, IEEE Std. 802.16-2004.

In one embodiment, the data transmitted between two or more networked devices may be grouped together to facilitate data management, (e.g., quality of service management). In the context of the disclosed subject matter, such groupings may be referred to as service flows, or data service flows. In various embodiments, the data may be grouped based upon various characteristics. For example, all data in a particular service flow may utilize a particular network port(s) (e.g., web traffic, file transfer traffic, video game traffic, etc.). In another example, all data in a particular service flow may be of a certain type (e.g., real time video data, buffered video data, real time voice data, etc.). Furthermore, service flows, in one embodiment, may share a common source network address, destination network address, or both. For example, multiple service flows may include data of similar types and network port usage but may be differentiated by the destination of the service flow. In one embodiment, the use of service flows may allow the granting or management of bandwidth from a base station 212 (or other device) to a mobile station 216 based upon various characteristics of the data transmitted and the policy rules for such data.

Likewise, data classification, in this context, may typically be the mapping of data onto a particular data transport connection for the transmission of the data between network devices. In one embodiment, data classification may include the assignment of data to a particular data service flow. In other embodiments, data classification may include selecting a particular route for the data, enabling a service associated with the data, providing a quality of service to the data, associating the data with a data service flow, refusing to forward the data, updating an address binding, etc.. In various embodiments, the data classification may be facilitated by the use of a rule set or a data classification rule set that provides a programmatic response to a set of conditions.

With the above orienting discussion in mind, in one embodiment, the system 201 may include a base station 212 that is configured to communicatively couple a mobile station 216 with a foreign network 203. In various embodiments, the base station 212 may be coupled with the mobile station 216 via a wireless communication link.

In one embodiment, the mobile station 216 may be configured to communicate with a home network 205 via the foreign network 203. In various embodiments, the mobile station 216 may be associated with a home network address and a care-of foreign network address, as described above.

In one embodiment, the system 201 may include an access network gateway 206 that is configured to communicatively couple the foreign network 203 with the home network 205 and transfer data between the mobile station 216 and the home network 205. In various embodiments, the access network gateway 206 may also be configured to perform data classification upon data transmitted to/from the mobile station 216 using, at least in part, the home network address associated with the mobile station 216. In other embodiments, the base station 212 may perform the data classification as described below in reference to the access network gateway 206.

In one embodiment, the access network gateway 206 may be configured to receive a home network address associated with the mobile station 216. In some embodiments, the access network gateway 206 may receive the home network address from the mobile station 216. In other embodiments, the access network gateway 206 may receive the home network address from the home agent 222 or another device.

In one embodiment, the access network gateway 206 may be configured to authenticate the association of the home network address and the mobile station 216. In various embodiments, the access network gateway 206 may request authentication from or use the access network authentication engine 204 or, in one embodiment, the home network authentication engine 210. In some embodiments, the network authentication engine(s) may include an Authentication, Authorization and Accounting (AAA) access control, policy enforcement, and auditing framework for computing systems. In one embodiment, the access network gateway 206 may consider the association between the home network address and mobile station 216 self-authenticating (e.g., if the association is transmitted from the home agent 222).

In one embodiment, the access network gateway 206 may be configured to create a data classification rule set that indicates that the home network address is associated with at least one data service flow. These associations may be, in one embodiment, created dynamically as new data is transmitted to/from the mobile station 216 or, in one embodiment, preconfigured. In various embodiments, the home network address may be associated with a plurality of data service flows, each data service flow including different data types, network port usage, etc.. In another embodiment, the association between home network address and data classification rule set may be one-to-one. In yet another embodiment, the association may be many-to-one (e.g., multiple home network addresses may be associated with a particular data classification rule set). In such an embodiment, a range of home network addresses may be associated with a data service flow (e.g., by using a wildcard, etc.).

In one embodiment, the access network gateway 206 may be configured to receive data. In one embodiment, the data may be transmitted from the mobile station 216 to another device. In another embodiment, the data may be transmitted from another device to the mobile station 216. While the discussion below may focus upon the transmission of data to the mobile station 216, it is understood that the case of transmission from the mobile station 216 is analogous to that described.

In one embodiment, the data transmitted to/from the mobile station 216 may include, as described above, an outer header having a foreign network address associated with the mobile station 216. In one embodiment, the data transmitted to the mobile station 216 may include, as described above, an inner or encapsulated header having the home network address associated with the mobile station 216. In the case where the data is transmitted from the mobile station 216 the addresses may be source addresses. Whereas, in the case where the data is transmitted to the mobile station 216 the addresses may be destination addresses.

In one embodiment, the access network gateway 206 may be configured to determine whether the foreign network address is the network address of either a foreign agent 207 or the mobile station 216. In such an embodiment, the access network gateway 206 may be configured to determine if the mobile station 216 appears to be operating in either “foreign agent care-of address” mode or “co-located care-of address” mode, as described above.

In one embodiment, the access network gateway 206 may be configured to, if the mobile station 216 is operating in “foreign agent care-of address” mode, perform data classification based upon the foreign network address, or the outer header of the data. However, in other embodiments, the access network gateway 206 may be configured to perform data classification using the encapsulated header, as described below. In various embodiments, the access network gateway 206 may be configured to select between the two classification techniques based upon a preconfigured set of policy rules; although it is understood that the above are merely a few illustrative examples to which the disclosed subject matter is not limited.

In one embodiment, the access network gateway 206 may be configured to, if the mobile station 216 is operating in “co-located care-of address” mode or otherwise as described above, read the encapsulated header of the data to determine the home network address associated with the mobile station 216. In one embodiment, if the home network address is not found in the encapsulated header, or if no encapsulated header exists, the access network gateway 206 may be configured to perform data classification based upon the foreign network address, or the outer header of the data.

In one embodiment, the access network gateway 206 may be configured to perform data classification using, at least the home network address of the encapsulated header. In various embodiments, the access network gateway 206 may be configured to ignore the foreign network address of the outer header when performing the data classification.

In one embodiment, the access network gateway 206 may be configured to match the home network address to at least one data service flow. In some embodiments, the access network gateway 206 may match the address to a service flow using a wildcard or a many-to-one mapping. In various embodiments, the access network gateway 206 may be configured to perform the matching by selecting at least one candidate data service flow that is associated with the home network address from a plurality of data service flows.

The access network gateway 206 may be configured to then, in one embodiment, acquire data characteristics (e.g., data type, network port usage, etc.) from the data. In some embodiments, the data may include a plurality of headers that may include more than just the outer header and encapsulated header. For example, the data may include more than just the outer and encapsulated headers (e.g., a virtual private network (VPN) header, a virtual local area network (VLAN) header, a link layer control (LLC) header, a Media Access Control (MAC) header, etc.). In various embodiments, some or all of these headers may include information or data characteristics (e.g., data type, network port usage, encryption scheme, data source, data destination, etc.). It is understood that the above are merely a few illustrative examples to which the disclosed subject matter is not limited.

In such an embodiment, the access network gateway 206 may be configured to inspect the plurality of headers to acquire data characteristics. The access network gateway 206 may be configured to select a data service flow, from among the candidate data service flows using the acquired data characteristics. In one embodiment, the access network gateway 206 may be configured to associate the data with the matched data service flow.

In one embodiment in which data classification includes more than data service flow management, the access network gateway 206 may be configured to match the home network address to at least one data classification rule set. In such an embodiment, the access network gateway 206 may be configured to perform the operation dictated by the data classification rule set. In various embodiments, the operations may include actions, such as, for example, selecting a particular route for the data, enabling a service associated with the data, providing a quality of service to the data, associating the data with a data service flow, refusing to forward the data, updating an address binding, etc.; although, it is understood that the above are merely a few illustrative examples to which the disclosed subject matter is not limited.

In one embodiment, the access network gateway 206 may be configured to forward the data to the next destination based upon the assigned service flow. In various embodiments, this may include transmitting the data via the tunnel 202 to the home network 205. In other embodiments, this may include transmitting the data to the foreign agent 207 or the mobile station 216. In one embodiment, the assigned service flow may dictate the route, rate, protocol, etc. used to transmit the data.

It is understood that, in one embodiment, the base station 212 may be configured to perform the actions described above in relation to the access network gateway 206. In various embodiments, the base station 212 may perform the actions whereas the access network gateway 206 does not. In other embodiments, both the access network gateway 206 and the base station 212 may perform the actions. In yet another embodiment, the base station 212 and the access network gateway 206 may include different data classification rule sets or parameters.

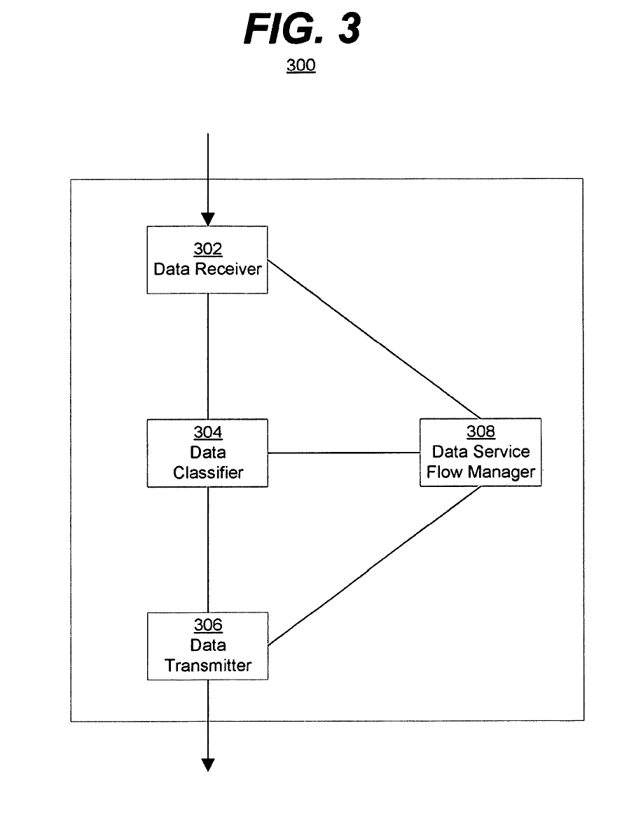

FIG. 3 is a block diagram illustrating an apparatus 300 in accordance with the disclosed subject matter. In one embodiment, the apparatus 300 may include a data receiver 302, a data classifier 304, and a data transmitter 306. In further embodiments, the apparatus 300 may also include the data service flow manager 308.

In one embodiment, the data receiver 302 may be configured to receive data. In one embodiment, the data receiver 302 may be configured to receive data that is directed to a mobile station (e.g., mobile station 216) that is coupled with a foreign network. In some embodiments, the data receiver 302 may be configured to receive data that includes an outer header having a foreign network address associated with the mobile station and an encapsulated header having a home network address associated with the mobile station, as described above. In some embodiments, the data receiver 302 may also be configured to receive data that is directed from a mobile station.

In one embodiment, the data transmitter 306 may be configured to transmit the data to the foreign network address. More generally, in some embodiments, the data transmitter 306 may be configured to transmit the data to a destination network address found in the outer header of the data. In the specific example above, to which the disclosed subject matter is not limited, the destination network address may be the foreign network address.

In one embodiment, the data classifier 304 may be configured to read the encapsulated header to determine the home network address, and assign the data to a data service flow using at least the home network address of the encapsulated header, as described above. In one embodiment, the data classifier 304 may be configured to determine if the foreign network address includes the network address of either a foreign agent (e.g., foreign agent 207) or the mobile station (e.g., mobile station 216). If the foreign network address includes the network address of the mobile station, the data classifier 304 may be configured to, in one embodiment, read the encapsulated header to determine the home network address; and assign the data to a data service flow using at least the home network address of the encapsulated header. Conversely, if the foreign network address includes the network address of the foreign agent, the data classifier 304 may be configured to, in one embodiment, perform data classification using the foreign network address, as described above.

In one embodiment, the data classifier 304 may be configured to receive an association between a home network address and a mobile station. Furthermore, in various embodiments, the data classifier 304 may be configured to authenticate the association. In some embodiments, the data classifier 304 may be configured to authenticate the association between a home network address and a mobile station using a Network Authorization Engine (e.g., Access Network Authorization Engine 204) or other device, as described above. In one embodiment, the data classifier 304 may be configured to map the home network address to a data service flow associated with the mobile station. In various embodiments, the data classifier 304 may be configured to, upon receipt of data that has a destination that includes the home network address, assign the data to the data service flow using the mapping of the home network address to the data service flow.

In one embodiment, the data service flow manager 308 may be configured to manage the quality of service provided to a plurality of data service flows. In some embodiments, each data service flow may include a data grouping based upon characteristics common to the grouped data and the destination of the data, as described above. In some embodiments, the data service flow manager 308 and data classifier 304 may be integrated.

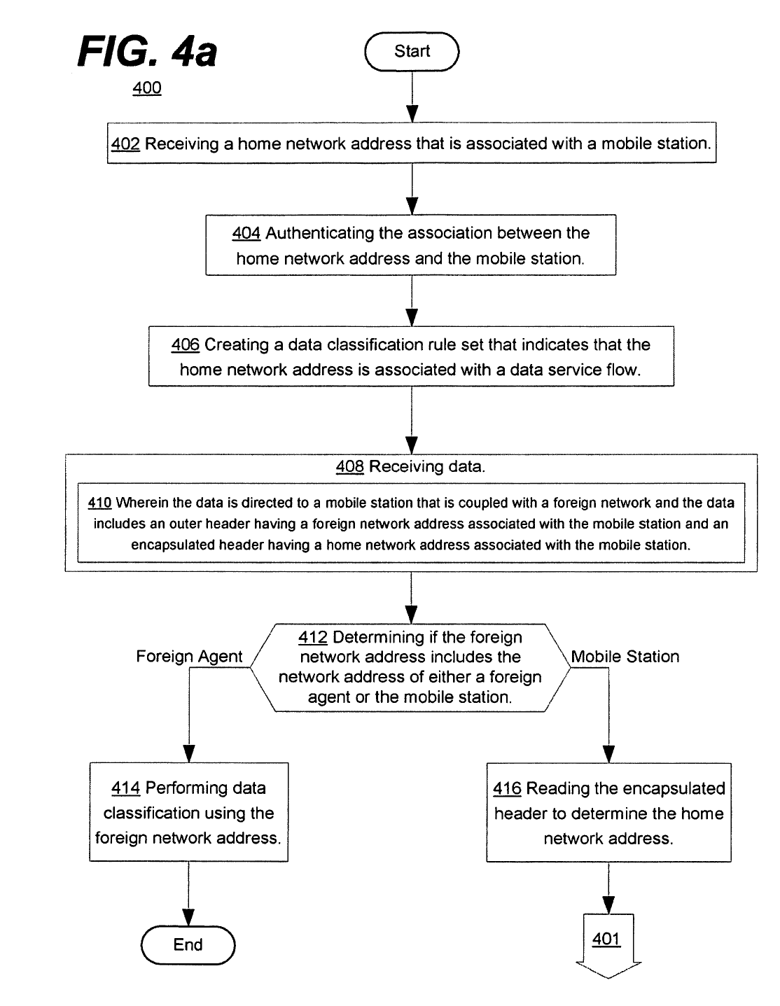

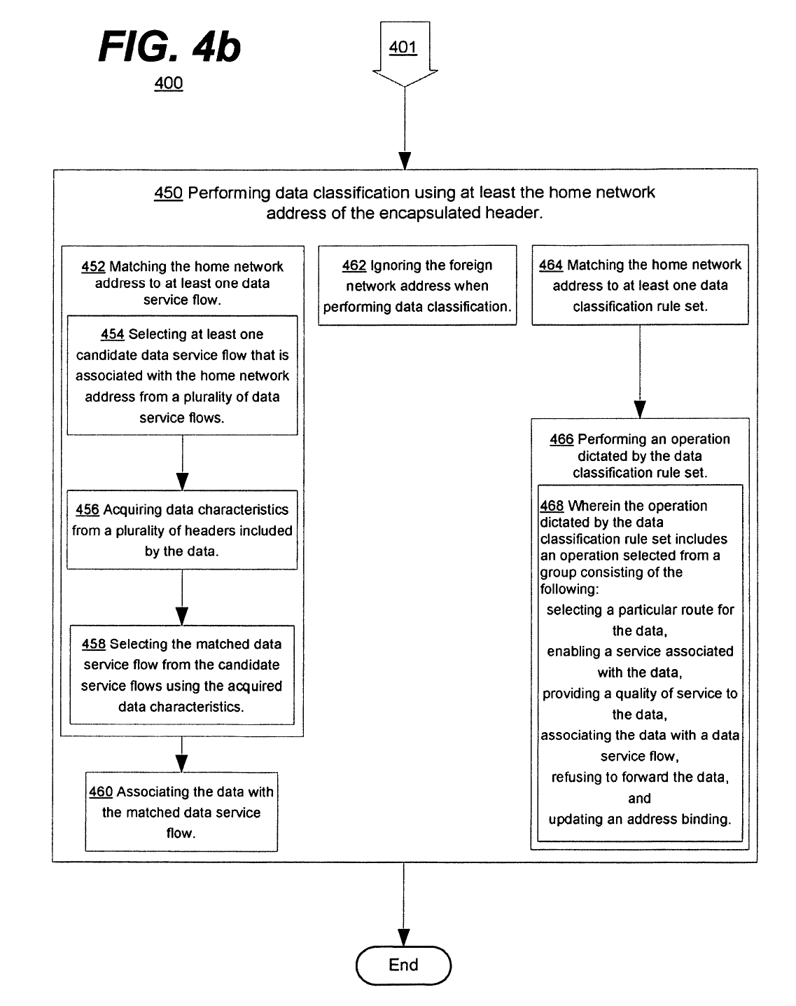

FIG. 4 is a flow chart illustrating a technique 400 of an embodiment in accordance with the disclosed subject matter. It is understood that FIGS. 4a and 4b represent a single flowchart illustrated on two pages. The connector 401 provides a way to represent the connection between the two pages. Hereafter and here-before, the flowchart of the technique 400 is simply referred to as FIG. 4, as if the flowchart merely occupied a single page.

Block 402 illustrates that, in one embodiment, a home network address that is associated with a mobile station may be received by a device, as described above. In some embodiments, the home network address may be associated with or assigned to the mobile station 216 of FIG. 2, as described above. In various embodiments, an association may be received by the base station 212, foreign agent 207, or Access Network Gateway 206 of FIG. 2 or the data classifier 304 of FIG. 3, as described above.

Block 404 illustrates that, in one embodiment, the association between the home network address and a mobile station may be authenticated by a device, as described above. In some embodiments, a network authentication engine (e.g., access network authentication engine 204 or home network authentication engine 210 of FIG. 2) may be used in the authentication process, as described above. In various embodiments, an authentication may be performed by the base station 212, foreign agent 207, or Access Network Gateway 206 of FIG. 2 or the data classifier 304 of FIG. 3, as described above.

Block 406 illustrates that, in one embodiment, a data classification rule set may be created that indicates that the home network address is associated with certain operations, as described above. In one such embodiment, the operation may indicate that the data is to be associated with a particular data service flow, as described above. In various embodiments, the creation may be performed by the base station 212, foreign agent 207, or Access Network Gateway 206 of FIG. 2 or the data classifier 304 of FIG. 3, as described above.

Block 408 illustrates that, in one embodiment, data may be received by a device, as described above. In various embodiments, the receipt may be performed by the base station 212, foreign agent 207, or Access Network Gateway 206 of FIG. 2 or the data receiver 302 of FIG. 3, as described above.

Block 410 illustrates that, in one embodiment, the received data may include an outer header having a foreign network address associated with the mobile station and an encapsulated header having a home network address associated with the mobile station, as described above. In one embodiment, the foreign network address may be assigned to a foreign agent. In yet another embodiment, the foreign network address may be assigned to the mobile station. In various embodiments, the data may be directed towards the mobile station. In which case, the foreign and home network addresses may be destination addresses. Conversely, in some embodiments, the data may be directed from the mobile station. In which case, the foreign and home network addresses may be source addresses.

Block 412 illustrates that, in one embodiment, a determination may be made as to whether the foreign network address includes or is assigned to a foreign agent or the mobile station, as described above. In various embodiments, the determination may be performed by the base station 212, foreign agent 207, or Access Network Gateway 206 of FIG. 2 or the data classifier 304 of FIG. 3, as described above.

Block 414 illustrates that, in one embodiment, if the foreign network address is assigned to a foreign agent, data classification may be performed using the outer header, as described above. In such an embodiment, the data classification may be performed using the foreign network address and/or other data characteristics. In various embodiments, the data classification may be performed by the base station 212, foreign agent 207, or Access Network Gateway 206 of FIG. 2 or the data classifier 304 of FIG. 3, as described above.

Block 416 illustrates that, in one embodiment, if the foreign network address is assigned to a mobile station, the encapsulated header may be read or inspected in order to determine the home network address, as described above. In various embodiments, the reading may be performed by the base station 212, foreign agent 207, or Access Network Gateway 206 of FIG. 2 or the data classifier 304 of FIG. 3, as described above.

Block 450 illustrates that, in one embodiment, if the foreign network address is assigned to a mobile station, data classification may be performed using the encapsulated header, as described above. In such an embodiment, the data classification may be performed using the home network address and/or other data characteristics. In various embodiments, the data classification may be performed by the base station 212, foreign agent 207, or Access Network Gateway 206 of FIG. 2 or the data classifier 304 of FIG. 3, as described above.

Block 452 illustrates that, in one embodiment, performing may include matching the home network address to at least one data service flow, as described above. In various embodiments, the matching may be performed by the base station 212, foreign agent 207, or Access Network Gateway 206 of FIG. 2 or the data classifier 304 of FIG. 3, as described above.

Block 454 illustrates that, in one embodiment, matching may include selecting at least one candidate service flow that is associated with the home network address from a plurality of data service flows, as described above. For example, in one embodiment, a number of service flows may be associated with the home network address (e.g., a video based service flow, a web based service flow, a voice based service flow, etc.). In such an embodiment, all of these data service flows may be selected as candidate service flows. In various embodiments, the selection may be performed by the base station 212, foreign agent 207, or Access Network Gateway 206 of FIG. 2 or the data classifier 304 of FIG. 3, as described above.

Block 456 illustrates that, in one embodiment, matching may include acquiring data characteristic(s) from at least one header included by the data, as described above. For example, the data may include more than just the outer and encapsulated headers (e.g., a virtual private network (VPN) header, a virtual local area network (VLAN) header, a link layer control (LLC) header, a Media Access Control (MAC) header, etc.). In various embodiments, some or all of these headers may include information or data characteristics that match to a particular data service flow (e.g., data type, network port usage, encryption scheme, data source, data destination, etc.). In various embodiments, the acquisition of these data characteristics may be performed by the base station 212, foreign agent 207, or Access Network Gateway 206 of FIG. 2 or the data classifier 304 of FIG. 3, as described above.

Block 458 illustrates that, in one embodiment, matching may include selecting a particular or matched service flow from among the candidate data service flows, as described above. In such an embodiment, the matched data service flow may be selected using the acquired data characteristics. In various embodiments, the selection may be performed by the base station 212, foreign agent 207, or Access Network Gateway 206 of FIG. 2 or the data classifier 304 of FIG. 3, as described above.

Block 460 illustrates that, in one embodiment, performing may include associating the data with the matched data service flow, as described above. In such an embodiment, the association may include assigning the data to the matched service flow. In various embodiments, the association may be performed by the base station 212, foreign agent 207, or Access Network Gateway 206 of FIG. 2 or the data classifier 304 of FIG. 3, as described above. In some embodiments, once associated with or assigned to a service flow the management of the service flow and the data may be performed by the base station 212, foreign agent 207, or Access Network Gateway 206 of FIG. 2 or the data service flow manager 308 of FIG. 3, as described above.

Block 462 illustrates that, in one embodiment, performing may include ignoring the foreign network address, as described above. In such an embodiment, performing may include ignoring the outer header, as described above. In various embodiments, the ignoring may be performed by the base station 212, foreign agent 207, or Access Network Gateway 206 of FIG. 2 or the data classifier 304 of FIG. 3, as described above.

Block 464 illustrates that, in one embodiment, performing may include matching the home network address to at least one data classification rule set, as described above. In various embodiments, the matching may be performed by the base station 212, foreign agent 207, or Access Network Gateway 206 of FIG. 2 or the data classifier 304 of FIG. 3, as described above.

Block 466 illustrates that, in one embodiment, performing may include performing an operation or operations dictated by the matched data classification rule set, as described above. Block 468 illustrates that, in one embodiment, the dictated operations may include operations, such as, for example, selecting a particular route for the data, enabling a service associated with the data, providing a quality of service to the data, associating the data with a data service flow, refusing to forward the data, updating an address binding, etc.; although, it is understood that the above are merely a few illustrative examples to which the disclosed subject matter is not limited. In various embodiments, the operations may be performed by the base station 212, foreign agent 207, or Access Network Gateway 206 of FIG. 2; or the data classifier 304, or the data service flow manager 308 of FIG. 3, as described above.

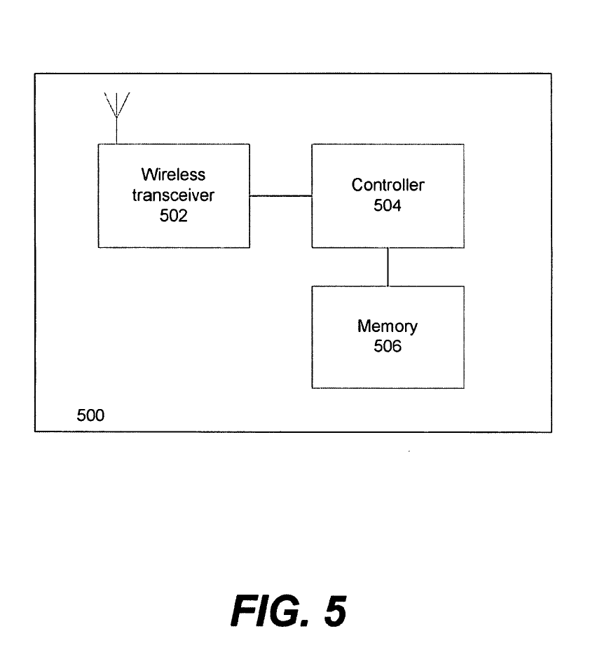

FIG. 5 is a block diagram of a wireless node according to an example embodiment. The wireless node 500 may include a wireless transceiver 502, and a controller 504, and a memory 506. For example, some operations illustrated and/or described herein, may be performed by a controller 504, under control of software or firmware.

In addition, a storage medium may be provided that includes stored instructions, which when executed by a controller or processor may result in a controller, or processor, performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
receiving data from a home agent,
wherein the data is directed to a mobile station that is coupled with a foreign network and the data includes an outer header having a foreign network address associated with the mobile station and an encapsulated header having a home network address associated with the mobile station;
reading the encapsulated header to determine the home network address; and
performing data classification using at least the home network address of the encapsulated header, wherein performing data classification includes:
matching the home network address to at least one data service flow; and
associating the data with the matched data service flow.

2. The method of claim 1 wherein matching includes:
selecting at least one candidate data service flow that is associated with the home network address from a plurality of data service flows;
acquiring data characteristics from a plurality of headers included by the data; and
selecting the matched data service flow from the candidate service flows using the acquired data characteristics.

3. The method of claim 1 further including:
determining if the foreign network address includes the network address of either a foreign agent or the mobile station, if the foreign network address includes the network address of the mobile station, reading the encapsulated header to determine the home network address; and performing data classification using at least the home network address of the encapsulated header.

4. The method of claim 3 further including, if the foreign network address includes the network address of the foreign agent, performing data classification using the foreign network address.

5. The method of claim 1 wherein performing data classification includes ignoring the foreign network address when performing data classification.

6. The method of claim 1 further including:
receiving a home network address that is associated with a mobile station;
authenticating the association between the home network address and the mobile station; and
creating a data classification rule set that indicates that the home network address is associated with a data service flow.

7. The method of claim 1 wherein performing data classification includes:
matching the home network address to at least one data classification rule set; and
performing an operation dictated by the data classification rule set.

8. The method of claim 7 wherein the operation dictated by the data classification rule set includes an operation selected from a group consisting of the following:
selecting a particular route for the data, enabling a service associated with the data, providing a quality of service to the data, associating the data with a data service flow, refusing to forward the data, and updating an address binding.

9. The method of claim 1 further including:
determining whether or not the mobile station is operating in co-located care-of-address mode; and
if so, reading the encapsulated header to determine the home network address, and if so, performing data classification using at least the home network address of the encapsulated header.

10. An apparatus comprising:
a data receiver configured to receive data,
wherein the data is directed to a mobile station that is coupled with a foreign network and the data includes an outer header having a foreign network address associated with the mobile station and an encapsulated header having a home network address associated with the mobile station;
a data classifier configured to:
read the encapsulated header to determine the home network address, and
assign the data to a data service flow using at least the home network address of the encapsulated header; and
a data transmitter configured to transmit the data to the foreign network address.

11. The apparatus of claim 10 further comprising:
a data service flow manager configured to manage the quality of service provided to a plurality of data service flows; and
wherein each data service flow includes a data grouping based upon characteristics common to the grouped data and the destination of the data.

12. The apparatus of claim 10 wherein the data classifier is configured to:
determine if the foreign network address includes the network address of either a foreign agent or the mobile station; and
if the foreign network address includes the network address of the mobile station, read the encapsulated header to determine the home network address; and assign the data to a data service flow using at least the home network address of the encapsulated header.

13. The apparatus of claim 12 wherein the data classifier is configured to:
if the foreign network address includes the network address of the foreign agent, perform data classification using the foreign network address.

14. The apparatus of claim 10 wherein the data classifier is configured to:
receive an association between a home network address and a mobile station;
authenticate the association;
map the home network address to a data service flow associated with the mobile station; and
upon receipt of data that has a destination that includes the home network address, assign the data to the data service flow using the mapping of the home network address to the data service flow.

15. The apparatus of claim 14 wherein the data classifier is configured to authenticate the association between a home network address and a mobile station using an Access Network Authorization Engine.

16. The apparatus of claim 10 wherein the data receiver is configured to receive data,
wherein the data is sent from the mobile station to a destination device and the data includes an outer header having a foreign network address associated with the mobile station and an encapsulated header having a home network address associated with the mobile station; and
the data transmitter is configured to transmit the data to destination device.

17. A system comprising:
a base station configured to communicatively couple a mobile station with a foreign network,
wherein the mobile station is configured to communicate with a home network via a foreign network and the mobile station is associated with a home network address and a care-of foreign network address; and
an access network gateway configured to:
communicatively couple the foreign network with the home network,
transfer data between the mobile station and the home network,
wherein the data includes an outer header having the care-of foreign network address associated with the mobile station and an encapsulated header having a home network address associated with the mobile station, and
assign the data to a data service flow based, at least in part, upon the home network address associated with the mobile station.

18. The system of claim 17 wherein the access network gateway is configured to:
determine if the care-of foreign network address that is associated with the mobile station is assigned to either the base station or the mobile station;
if the care-of foreign network address is assigned to the mobile station, assign the data to a data service flow based, at least in part, upon the home network address associated with the mobile station; and
if the care-of foreign network address is assigned to the base station, assign the data to a data service flow based, at least in part, upon the care-of foreign network address assigned to the base station.

19. The system of claim 17 wherein the base station is configured to:
transfer data between the mobile station and the home network, wherein the data includes an outer header having the care-of foreign network address associated with the mobile station and an encapsulated header having a home network address associated with the mobile station; and
assign the data to a data service flow based, at least in part, upon the home network address associated with the mobile station.

20. The system of claim 17 wherein the access network gateway is configured to:
receive an association between a home network address and the mobile station;
authenticate the association;
map the home network address to a data service flow associated with the mobile station; and
upon receipt of data that has a destination that includes the home network address, assign the data to the data service flow using the mapping of the home network address to the data service flow.
